(19) United States
(12) Patent Application Publication
(10) Pub. No.: US 2017/0082975 A1
(43) Pub. Date: Mar. 23, 2017

(54) LENSLESS IMAGING DEVICE AND ASSOCIATED METHOD OF OBSERVATION

(71) Applicant: Commissariat A L'Energie Atomique et aux Energies Alternatives, Paris (FR)

(72) Inventors: Alain GLIERE, Grenoble (FR); Salim BOUTAMI, Grenoble (FR); Alexei TCHELNOKOV, Meylan (FR); Ivan VOZNYUK, Grenoble (FR); Cedric ALLIER, Grenoble (FR)

(73) Assignee: Commissariat A L'Energie Atomique et aux Energies Alternatives, Paris (FR)

(21) Appl. No.: 15/274,108

(22) Filed: Sep. 23, 2016

(30) Foreign Application Priority Data
Sep. 23, 2015 (FR) 15 58980

(51) Int. Cl. G03H 1/04; G03H 1/00

(52) U.S. Cl. CPC G03H 1/041; G03H 1/0005; G03H 1/0443; G03H 2001/005; G03H 2001/0212

(57) ABSTRACT

The invention describes a device allowing the observation of a sample, comprising particles, for example biological particles, by lensless imaging. The sample is disposed against a substrate, the substrate being interposed between a light source and an image sensor. The substrate comprises at least one thin film, extending across a thin film plane, structured so as to form a diffraction grating, designed to confine a part of a light wave emitted by the light source, in a plane parallel to said thin film plane. The device does not comprise magnification optics between the substrate and the image sensor.

### TECHNICAL FIELD

The technical field of the invention is the observation of a sample comprising particles by lensless imaging.

### PRIOR ART

The observation of samples, and in particular biological samples, by lensless imaging has undergone a significant development over the last ten years. This technique allows a sample to be observed by placing it between a light source, producing an incident light wave, and a photodetector array, without having any optical magnification system between the sample and the photodetector. Thus, the photodetector acquires an image of a light wave transmitted by the sample.

This image is composed of interference patterns between the incident light wave emitted by the source and transmitted by the sample, and diffraction waves, resulting from the diffraction, by particles present in the sample, of the incident light wave. These interference patterns are sometimes referred to as “diffraction patterns”.

The document WO2008090330 describes a device allowing the observation of biological particles, in the present case cells, by lensless imaging. The device allows a diffraction pattern to be associated with each cell whose morphology allows the type of cell to be identified. Lensless imaging is accordingly seen as a simple, and low-cost, alternative to a conventional microscope. In addition, it allows a field of observation to be obtained that is much more extensive than that of a microscope can be. It will accordingly be understood that the application possibilities associated with this technology are significant.

The document US2012/0218379, subsequent to the preceding document, covers the essential part of the teachings of WO2008090330, while at the same time describing holographic reconstruction algorithms which, when applied to the image formed on the detector, allow the image of the sample to be reconstructed in various reconstruction planes.

The document WO2011045360 describes the use of a similar technology for the observation of particles contained in a liquid film covering a transparent medium. Each particle forms a diffraction pattern on the surface of a detector, whose contrast is amplified when the thickness of the film is reduced.

Thus, lensless imaging allows a sample comprising particles to be observed on the basis of elementary patterns formed by each particle under the effect of an illumination by an incident wave.

In view of the interest aroused by this technology, notably for applications in healthcare, food-processing or the environment, the inventors have sought to improve its performance characteristics and, in particular, the sensitivity and the contrast of the patterns formed by each particle.

### DESCRIPTION OF THE INVENTION

The invention is proposing a device or a method such as described in the appended claims. The invention relates to a device for forming an image of a sample comprising:
a light source, configured to emit a light wave, referred to as incident wave, at a wavelength, along an axis of propagation, toward the sample;
an image sensor;
a substrate, configured to receive the sample, disposed between the light source and the image sensor;
the substrate comprising a first thin film, comprising a first material, transparent at said wavelength, with a first refractive index, extending across a plane, referred to as plane of the thin film,
said first thin film comprising a plurality of inclusions, formed from a second material, transparent at said wavelength, with a second refractive index;
the distance between two adjacent inclusions being less than said wavelength;
said inclusions defining a first diffraction grating, within said first thin film, designed to confine a part of the incident wave across a plane parallel to said thin film plane;
the device not comprising magnification optics between the substrate and the image sensor.

According to an embodiment, the first diffraction grating is a two dimensional diffraction grating. Using a two dimensional diffraction grating makes it possible to illuminate the substrate using a non-polarized light.

According to a preferred implementation, the first diffraction grating is configured for generating a resonant reflection of the incident wave at said wavelength so as to reflect a part of said incident light wave toward the light source. The image sensor is preferably placed in dark field.

According to an embodiment, the substrate is bounded by a lower face and an upper face. The first thin film is configured to confine a part of the incident light within a waveguide adjacent to one of said faces. The first thin film can be adjacent to one of said faces, the first diffraction grating being a resonant grating, configured to confine a part of the incident wave within said thin film plane, said first thin film then forming said waveguide. The substrate may also comprise a Bragg mirror, disposed between the light source and said first thin film, and formed by at least two adjacent layers, extending parallel to said thin film, formed from a third material with a third index and a fourth material with a fourth index, said third index being different from said fourth index. The third material and the fourth material may possibly correspond respectively to the first material and to the second material. The Bragg mirror can be placed at a distance from the first thin film substantially equal to an odd multiple of a quarter of the wavelength.

According to an embodiment, the substrate comprises a second thin film, extending parallel to said first thin film. The second thin film comprises a sixth material, transparent at said wavelength, with a sixth refractive index, as well as a plurality of inclusions, formed from a seventh material transparent at said wavelength, with a seventh refractive index. Two adjacent inclusions of said second thin film are separated from each other by a distance less than said wavelength, in such a manner that these inclusions define a diffraction grating in said second thin film, designed to confine a part of the incident wave in said second thin film. The distance between the first thin film and the second thin film is preferably less than said wavelength.

According to an embodiment, the substrate comprises a planar waveguide, extending parallel to the first thin film. The first thin film is disposed between the planar waveguide and the light source, the first diffraction grating is configured for generating an optical coupling with the planar waveguide, in such a manner that a part of the incident wave is coupled to said planar waveguide. The distance between the first thin film and the planar waveguide is preferably greater than zero and less than said wavelength. The substrate can be bounded by a lower face, disposed facing the image sensor, the planar waveguide being adjacent to said lower face.

The invention also relates to a method of observation of a sample, comprising a particle, the method comprising the following steps:
disposing the sample in contact with a substrate, said substrate being disposed between a light source and an image sensor;
illuminating the substrate and the sample by means of an incident light wave, produced by the light source;
the substrate comprising a first thin film, extending across a thin film plane, forming a first diffraction grating, confining a part of the incident wave in a plane parallel to said plane of the thin film, so as to form a confined beam propagating in said plane parallel to the thin film plane;
collecting, on the image sensor, a diffraction wave generated by said particle, and acquiring, by the image sensor, an image representative of this diffraction wave, the diffraction wave being formed by the particle from the confined beam, a part of the diffraction wave being detected by the image sensor.

The substrate preferably reflects a part of the incident wave and blocks a transmission of the incident wave toward the image sensor. The image sensor is operated in a so called dark field mode.

The substrate is preferably illuminated at a resonance wavelength of the first diffraction grating.

According to an embodiment, the confined beam propagates within the first diffraction grating.

According to an embodiment,
the substrate is bounded by a lower face and an upper face, the lower face being situated opposite to the image sensor;
the first thin film confines a part of the incident light within a waveguide adjacent to one of said faces, so as to form a beam referred to as ‘confined beam’ propagating within said waveguide;
the sample is placed in contact with the face bounding said waveguide.
   According to this embodiment, the confined beam propagates within the waveguide.

According to an embodiment, the substrate may also comprise a second thin film, extending parallel to said first thin film, and forming a second diffraction grating designed to confine a part of the incident wave within said second thin film, the first and the second thin film being separated from each other by a distance less than said wavelength, said distance being preferably greater than zero. According to this embodiment, the confined beam propagates within the second thin film.

According to an embodiment, the waveguide is a planar waveguide, adjacent to the lower face of the substrate, the first thin film acting so as to couple a part of the incident wave to said planar waveguide. The distance between the first thin film and the planar waveguide may be greater than zero.

The particle might be disposed at a distance from the waveguide, or from the substrate, of less than said wavelength. The particle can be a biological particle, for example a micro-organism or a virus or a cell.

The image enables the detection of a particle, together with its localization, in a plane extending parallel to the substrate. When the sample includes particles, it also allows to detect and localize some particles. The detected particles may be sorted by size, based on the image acquired by an image sensor

### FIGURES

FIG. 1A shows a first embodiment of the invention.

FIG. 1B is a cross-sectional view of one example of a diffraction grating.

FIG. 2A shows the result of simulations regarding the variation of the reflectance as a function of wavelength, according to the first embodiment. FIG. 2B shows the result of simulations demonstrating the variation in the intensity of the electric field at an interface of the diffraction grating and the substrate, as a function of wavelength, according to the embodiment shown in FIG. 1A.

FIG. 2C shows a pattern, referred to as a ‘diffraction pattern’, formed on an image sensor by a diffraction wave generated by a particle of diameter 100 nm placed against a substrate of the prior art, i-e without a diffraction grating. FIGS. 2D shows a pattern, referred to as a ‘diffraction pattern, formed on an image sensor by a diffraction wave generated by a particle of diameter 100 nm placed against a substrate according to the embodiment shown in FIG. 1A. FIG. 2E show a simulated profile of the intensity of a diffraction pattern formed, at a resonance wavelength of the diffraction grating, by a particle of diameter 100 nm according to a configuration of the prior art and according to the first embodiment, respectively.

FIG. 2F shows the variation, as a function of the diameter of an observed particle, of a ratio between the intensity of a diffraction pattern, at the resonance wavelength of the diffraction grating, according to the first embodiment, over the intensity of a diffraction pattern according to a configuration of the prior art.

FIG. 3 shows a second embodiment of the invention.

FIG. 4 shows a third embodiment of the invention.

FIG. 5A shows a fourth embodiment of the invention. FIG. 5B shows a comparison of the variation of the reflectance, as a function of wavelength, according to the first embodiment and according to the fourth embodiment. FIG. 5C shows a comparison of the intensity of the electric field at an interface of the diffraction grating and the substrate, as a function of wavelength, respectively according to the first embodiment and according to the fourth embodiment. FIG. 5D shows a profile of a diffraction pattern formed by a particle on an image sensor, at the resonance wavelength of the diffraction grating, according to the prior art, according to the first embodiment and according to the fourth embodiment, respectively.

FIG. 6A shows a fifth embodiment of the invention. FIG. 6B shows a comparison of the variation of the reflectance, as a function of wavelength, according to the first, the fourth and the fifth embodiment. FIG. 6C shows a comparison of the intensity of the electric field at an interface of the diffraction grating and the substrate, as a function of wavelength, according to the first, the fourth and the fifth embodiment, respectively. FIG. 6D shows a comparison of the image formed on the image sensor by a diffracting particle placed against the substrate, according to the first, the fourth and the fifth embodiment, respectively. FIG. 6E shows a profile of intensity of a diffraction pattern in the detection plane of the image sensor, at the resonance wavelength of the diffraction grating, according to the first, the fourth and the fifth embodiment, respectively.

FIGS. 7A and 7B show a simulation of the spatial distribution of the intensity of the electric field over the lower face of the substrate according to the fourth embodiment and the fifth embodiment, respectively.

FIG. 8A shows the results of simulations allowing the determination of the resonance wavelength of the diffraction grating described in the fifth embodiment as a function of the thickness of the planar waveguide and of the distance separating it from the diffraction grating. FIG. 8B shows the results of simulations allowing an estimation of the intensity of the electric field at an interface of the diffraction grating and the substrate according to the fifth embodiment, as a function of its thickness and of the distance separating it from the diffraction grating.

FIG. 9 shows a sixth embodiment.

FIG. 10A shows a seventh embodiment, comprising two diffraction gratings. FIG. 10B shows the reflectance, as a function of wavelength, of each grating taken individually and also of the combination of the two gratings. FIG. 10C shows the intensity of the electric field, as a function of wavelength, within each grating taken individually, together with the intensity of the electric field, as a function of wavelength, at an interface of the diffraction grating situated close to the lower face bounding the substrate, and the substrate.

FIG. 11A shows cylinder shaped silicon nitride inclusions in a silicon oxide thin layer, defining a two-dimensional grating. FIG. 11B shows the variation of the reflectance as a function of wavelength, using the two-dimensional grating displayed on FIG. 11A.

In these figures, the same references are used to denote the same elements.

### PRESENTATION OF PARTICULAR EMBODIMENTS

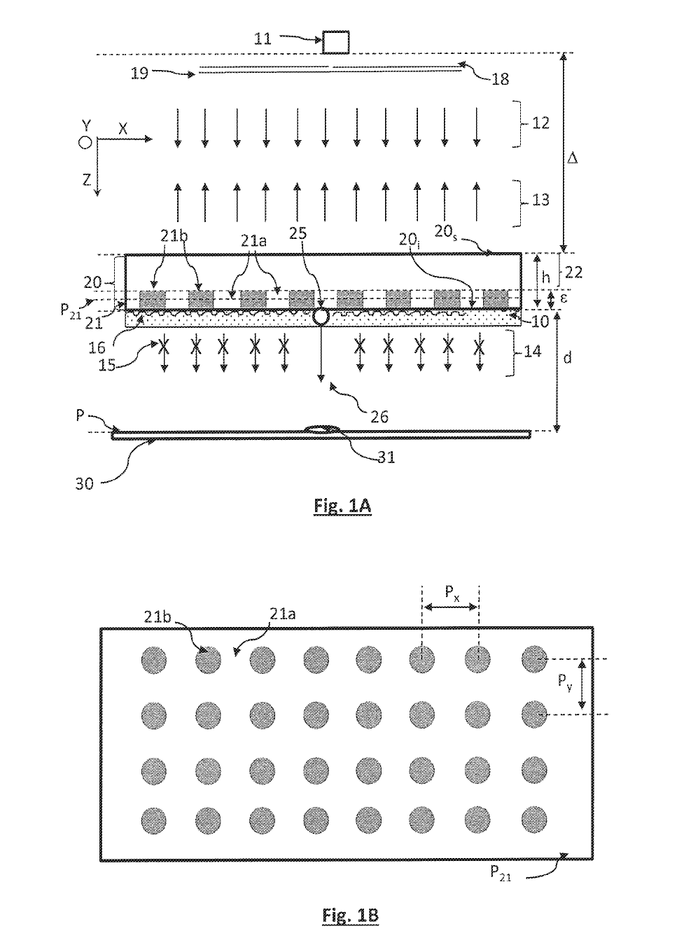

FIG. 1 shows a first embodiment of the invention. A light source 11 produces an incident light wave 12 in the direction of a substrate 20, the latter being disposed between the light source 11 and an image sensor 30.

The sample 10 to be analyzed is placed against a substrate 20. The substrate is bounded by an upper face 20ₛ, disposed facing the light source 11, and a lower face 20ᵢ, disposed facing the image sensor 30.

In this example, the sample is a liquid sample taking the form of a thin film, comprising particles 25 and extending against the lower face 20ᵢ of the substrate. Generally speaking, a particle has a size advantageously less than 1 mm, or less than 500 μm, and preferably a size in the range between 5 nm and 100 μm. This may be a biological particle, of the bacteria type, or other micro-organism, or a virus, or a cell, for example a blood cell, or a microbead.

The light source 11 is preferably a point source. It may comprise an aperture 18, or spatial filter. The opening of the aperture is typically in the range between 5 μm and 1 mm, preferably between 50 μm and 500 μm, for example 150 μm. The aperture may be replaced by an optical fiber, a first end of which is placed facing the light source 11 and a second end of which is placed facing the upper face 20ₛ of the substrate. The aperture 18 is optional. The light source is for example a laser source, like a laser-diode or a light-emitting diode. The emission spectral band of the light source is preferably adjusted to a resonance wavelength of a diffraction grating formed in the substrate, described in the following. The emission spectral band width may preferably be less than 50 nm, and more preferably less than 10 nm, and preferably less than 5 nm. The emission spectral band may be situated in the visible, near-UV (>200 nm), near-infrared (<3 μm) or mid-infrared (between 3 and 10 to 12 μm). A bandpass filter 19 may be disposed between the light source 11 and the substrate, in such a manner as to adjust the emission spectral band of the light source, in particular with respect to the resonance wavelength previously mentioned. The incident light wave 12 produced by the light source propagates along an axis of propagation Z. The light source 11 may also be a tunable light source, like a tunable laser By tunable, it is meant that the emission spectral band is tunable. The light source 11 can be a QCL (Quantum Cascade Laser), such as an external cavity laser.

The distance A between the light source 11 and the sample 10 is preferably greater than 1 cm and preferably in the range between 2 and 30 cm. Advantageously, the light source 11, seen by the sample 10, is considered as a point source. This means that its diameter (or its diagonal) is preferably less than a tenth, or better less than a hundredth, of the distance between the sample and the light source. Thus, the incident light wave 12 arrives at the substrate in the form of a plane wave, or wave that may be considered as such, the incidence being, in this example, normal.

The image sensor 30 is designed to form an image in a detection plane P. In the example shown, the emission spectral band of the light source is situated in the visible range. The image sensor 30 may accordingly be a photodetector array comprising a matrix of pixels, of the CCD or CMOS type. The detection plane P in this example extends perpendicularly to the axis of propagation Z of the incident light wave 12. The image sensor may comprise a system of the mirror type for reflecting an image toward a matrix of pixels, in which case the detection plane corresponds to the plane in which the image reflection system extends. Generally speaking, the detection plane P corresponds to the plane in which an image is formed.

The distance d between the sample 10 and the matrix of pixels of the image sensor 30 is, in this example, equal to 300 μm. Generally speaking, and irrespective of the embodiment, the distance d between the sample and the pixels of the image sensor is preferably in the range between 50 μm and 2 cm, more preferably in the range between 100 μm and 2 mm.

The absence of magnification optics between the image sensor 30 and the sample 10 is noted. This does not preclude the potential presence of focusing microlenses on each pixel of the image sensor 30, the latter not having the function of magnification of the image.

The substrate 20 comprises a uniform part 22, transparent to the incident radiation, with a thickness of a few hundred μm to a few mm. In this example, the thickness of this uniform part is of 725 μm. The substrate also comprises a nano-structured thin film 21. The term ‘thin film’ denotes a layer whose thickness E is less than 5 μm, or even than 1 μm. The thickness ε may notably be defined with respect to a wavelength λ of the emission spectral band, for example the central wavelength of the emission spectral band. Preferably, ε≦λ, or potentially ε≦λ/2. The thin film 21 is formed from a first dielectric material 21ₐ, transparent to all or part of the emission spectral band, this material having a first refractive index n₁. The thin film comprises inclusions, formed from a second dielectric material 21_{b}, transparent to all or part of the emission spectral band, with a second refractive index n₂. The difference between the first index and the second index is preferably greater than 0.1, or even 0.25.

When the emission spectral band is situated in the near-UV, the visible or the near-infrared, the first and second materials 21ₐ and 21_{b} are preferably dielectric materials, transparent in all or part of said emission spectral band. When the emission spectral band is situated in the near-infrared or the mid-infrared, the first and second materials 21ₐ and 21_{b} may be semiconductor materials (for example amorphous silicon or the germanium) or dielectrics (for example zinc sulfide) transparent in at least a part of the emission spectral band. Generally speaking, the first and second materials 21ₐ and 21_{b} forming the diffraction grating are transparent in all or part of the emission spectral band of the light source, and more particularly at the resonance wavelength described hereinafter.

In the present case, where the emission spectral band is situated in the visible spectrum, the first material 21ₐ is silicon oxide, or silica, (n₁≈1.5) and the second material 21_{b} is silicon nitride (n₂≈2).

The first thin film extends in a plane P₂₁, referred to as thin film plane, which is, in this example, perpendicular to the axis of propagation of the incident wave 12. Each inclusion 21_{b} takes the form of a cylinder, whose base, in the plane of the thin film, is circular or polygonal, the cylinder extending parallel to the axis of propagation of the incident wave 12. Each inclusion 21_{b} may also take the form of a cone or a truncated cone, with a circular or polygonal base, or have a hemispherical shape. Whichever shape is chosen, the dimension of each inclusion is micrometric, in other words, in the plane of the thin film, the largest dimension of each inclusion is less than the wavelength, in other words a “sub-wavelength” dimension. The inclusions are distributed according to a matrix arrangement. They define a two-dimensional grating, known as a diffraction grating, extending within the thin film 21. By two-dimensional grating, it is meant a grating including inclusions which are periodically distributed along two dimensions, i-e according to a matrix arrangement, there by defining a two dimensional periodic pattern.IN a two-dimensional grating, each inclusion is spaced apart from another inclusion according to both X and Y axes.

In the description relating to the first, second, third, fourth, fifth and sixth embodiments, the substrate comprises a single thin film 21, defining a diffraction grating. This thin film may also be denoted by the term “first thin film”, defining a first diffraction grating. The seventh embodiment comprises a substrate comprising two separate thin films, parallel to each other, respectively denoted by the term “first thin film” and the term “second thin film”.

FIG. 1B shows a cross-section of the thin film 21, across the thin film plane P₂₁. The thin film 21 is composed of oxide of silicon (silica), and comprises inclusions of silicon nitride defining a periodic pattern. Each inclusion has the shape of a cylinder with a circular base and with a diameter equal to 132 nm. The center-to-center distance for each inclusion is 264 nm, the period of the grating thus being 264 nm. The thickness E of the thin film is 130 nm. Also, in this example, the periodicity P_{X} and P_{Y} respectively according to the two axes X and Y of the plane of the thin film P₂₁ is identical. Owing to the fact of the periodicity along two axes of the same plane, the diffraction grating is said to be two-dimensional.

Generally speaking, the substrate 20 comprises a dielectric thin film 21, comprising inclusions preferably with sub-wavelength dimensions, defining a periodic diffraction grating. The periodic grating is generated based on a mesh, referred to as basic mesh, comprising one or more inclusions. Each mesh link is repeated periodically according to one or two translation vectors, in the plane of the thin film. The same mesh may contain inclusions with different shapes; this is then referred to as a ‘pseudo-periodic grating’.

The thin film 21 constitutes a resonant diffraction grating, sometimes referred to as a photonic crystal, exhibiting a resonance wavelength, at which the transmission and reflection properties of light may be determined by means of simulations performed by processing codes. Indeed, the propagation properties of light in the diffraction gratings derive from their specific periodic arrangement and are readily modeled, by those skilled in the art, on the basis of the spatio-temporal equations of Maxwell. In the following part of this description, the modeling is carried out with the aid of the Comsol software application, implementing a method of the FEM (Finite Element Method) type.

The term ‘diffraction grating’ is understood to mean a structure, and, in this example, a dielectric structure, whose index varies periodically at the scale of the wavelength, in one or more directions. The invention takes advantage of the development of techniques for micro-structuring of dielectric materials allowing the interaction of the electromagnetic waves within three-dimensional structures to be controlled based on the arrangement of materials with various indices. By virtue of the nanometric precision of the micro-fabrication methods, diffraction gratings corresponding to a material structuring scale in the neighborhood of a quarter or a half wavelength can now be formed, which makes it compatible with applications in optics.

In the present case, at the resonance wavelength, the diffraction grating formed by the layer 21, transparent to the other wavelengths, does not transmit light. At the resonance wavelength, the grating formed in the thin film allows a confinement of a part of the incident wave 12 in the plane of the thin film P₂₁, accordingly forming a confined beam.

The coupling ratio Γ of the photons of the incident wave 12 within the grating may reach for example 10%. The term ‘coupling ratio’ is understood to mean a ratio between a number of coupled photons and a number of incident photons. In this case, 10% of the incident flux is coupled to the resonant grating. The decoupling ratio of the grating, or leakage ratio, has the same value as the coupling ratio Γ, in this case 10%. When the substrate is illuminated by the source, at the resonance wavelength of the diffraction grating 21, the intensity of the confined electromagnetic beam in the diffraction grating increase virtually instantaneously, and may exceed 10 times the intensity of the incident radiation. The photons coupled to the diffraction grating compensate the losses coming from the decoupling. These losses take the form of a wave 13 propagating toward the light source, and of a wave 15 propagating toward the sensor, the waves 13 and 15 propagating parallel to the axis of propagation of light Z. The intensity of the wave 13 reflected by the grating in a direction opposite to the direction of propagation Z is equivalent to the intensity of the incident wave 12. Furthermore, the wave 15 formed by the losses of the grating in the direction of propagation Z is in phase opposition with a wave 14 transmitted by the substrate, the latter being formed by the part of the incident light wave 12 not coupled to the grating. Destructive interferences are then formed, blocking the exposure of the image sensor 30. These destructive interferences are symbolized, in FIG. 1A, by the symbol X. As a consequence the grating acts as a resonant mirror, with a reflection coefficient R, or reflectance, close to 1; this is referred to as resonant reflection. Under these conditions, the image sensor 30 is in a configuration called ‘dark field’, since it is not (or low) exposed to light coming from the substrate 20.

The thin film 21 is adjacent to the lower face 20ᵢ of the substrate 20. In this description, the term ‘adjacent’ should be understood as bounded by or distant by a distance of less than 10 μm, and notably less than the wavelength. When a particle 25 of the sample 10 is in contact with the lower face 20ᵢ or at a small enough distance from the latter, it interferes with the diffraction grating, the latter then transmitting the light. This results in the formation of a diffraction wave 26 propagating toward the image sensor 30. The latter being placed in dark field, the contrast formed by the diffraction wave 26, in the detection plane, is high. A diffraction pattern 31 is then acquired allowing the particle 25 to be detected, and potentially identified or localized in the detection plane P. A small enough distance is understood to mean a distance preferably smaller than the wavelength, or even preferably less than half or a quarter of the wavelength. The closer the particle is to the thin film 21, the higher the amplitude of the diffraction wave. Typically, the distance between the particle 25 and the thin film 21 is preferably less than 200 nm, preferably less than 100 nm, and even more preferably less than 50 nm.

Moreover, the high intensity of the electromagnetic field confined within the resonant grating of the thin film 21 increases by even more the intensity of the wave 26 diffracted by the particle 25. The intensity of the diffracted wave 26 is also reinforced by an evanescent field 16 being formed on the lower face 20ᵢ or on the thin film 21.

Thus, each particle being in contact with the lower face 20ᵢ becomes a diffracting particle, able to generate the formation of a diffraction pattern on the image sensor. The diffraction grating formed in the thin film 21 allows a diffraction pattern to be obtained in the detection plane whose contrast is high, by the combined effects of the reflection of the incident wave 12 and of the amplified intensity of the electromagnetic field in the resonant grating. This results in a high sensitivity for the device. This diffraction effect is obtained when the particle 25 is placed in a configuration called ‘in near field’, in other words at a sub-wavelength distance from the lower face 20ᵢ.

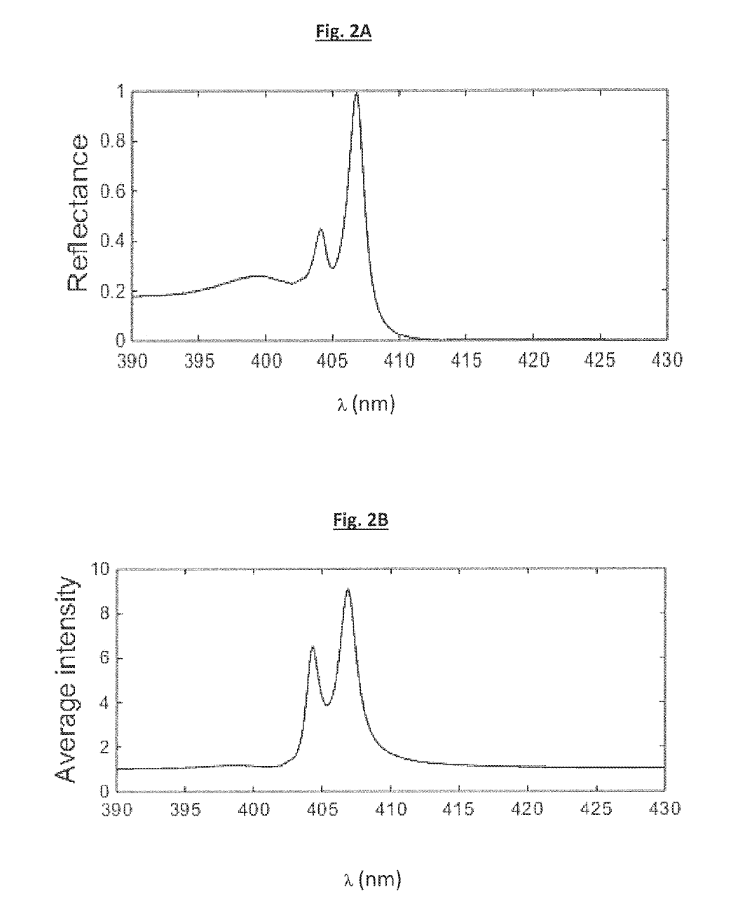

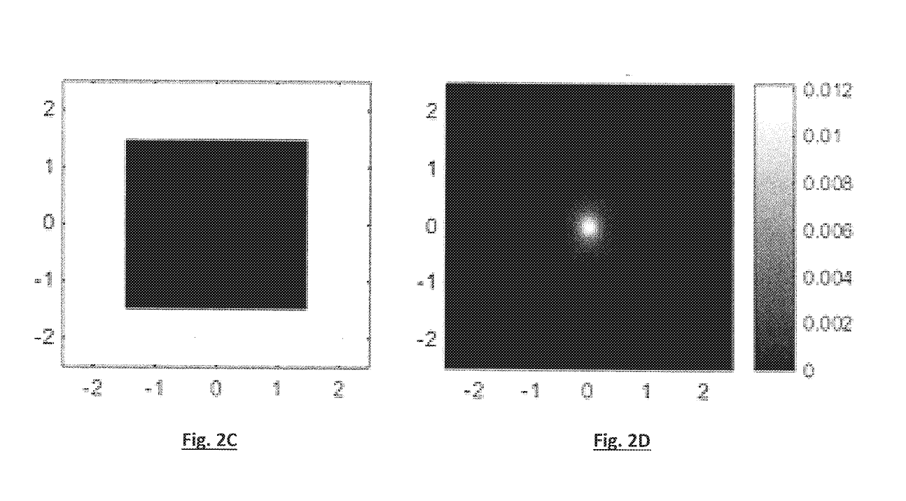

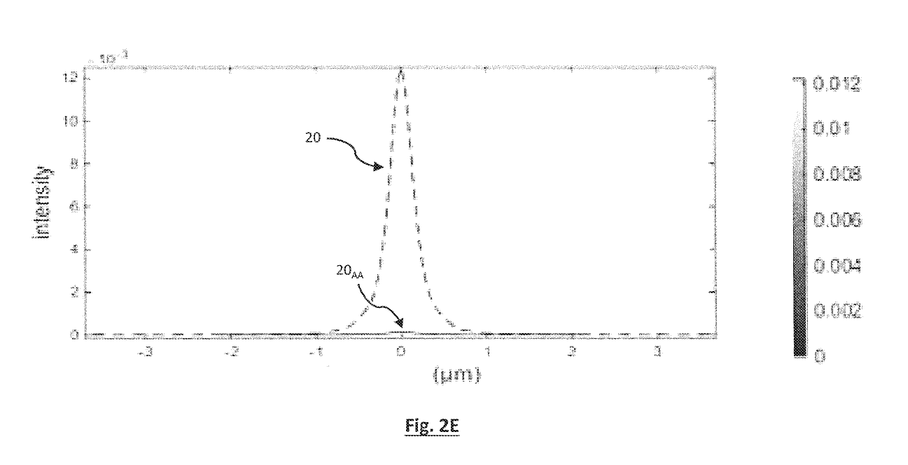

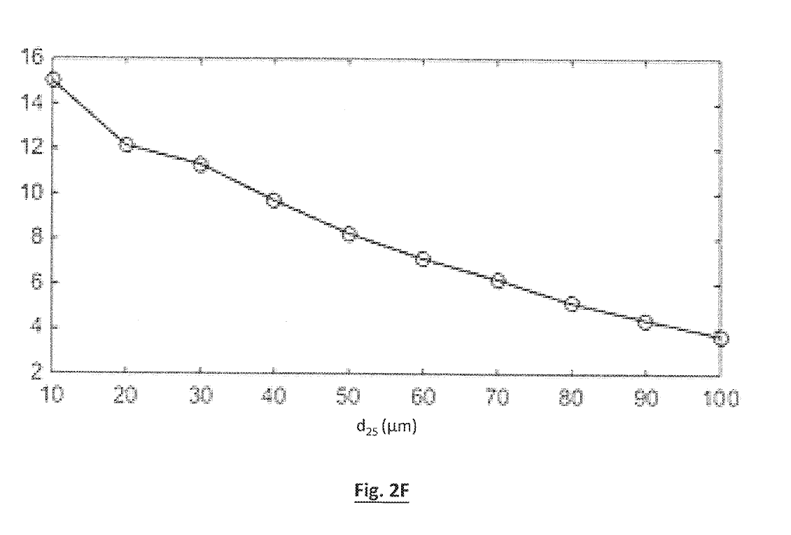

FIG. 2A is the result of a simulation representing, for the structure shown schematically in FIGS. 1A and 1B, the reflectance as a function of wavelength. The reflectance corresponds to a ratio between the intensity of the wave reflected 13 over the intensity of the incident wave 12. It can be seen that, at the resonance wavelength of 405 nm, the reflectance is close to 1. FIG. 2B is the result of a simulation representing, for the structure shown schematically in FIGS. 1A and 1B, the intensity of the electric field at the interface between the thin film 21 and the lower face 20ᵢ of the substrate, as a function of wavelength. It is observed that, at the resonance wavelength, the intensity of the electromagnetic field confined within the grating increases by a factor greater than 10 with respect to the non-resonant wavelengths.

This figure allows the quality factor Q of such a structure to be introduced, which is the ratio of the width of the resonance peak (Δλ) over the central wavelength of the resonance peak. The higher the quality factor, the more marked the resonance, but the finer the spectral selectivity of the grating.

FIG. 2C shows a simulation of a diffraction pattern formed, in the detection plane of the image sensor, by a diffraction wave generated by a particle with a diameter of 100 nm exposed to the incident wave 12, using a substrate of the prior art 20_{AA}, without a diffraction grating. This shows a configuration of the prior art. FIG. 2D shows a simulation of a diffraction pattern formed, by an identical particle, disposed against the lower face of the substrate 20. In the two simulations, the particle is a sphere with a diameter of 100 nm and an index of 1.5. The distance between the image sensor and the bead is 300 μm.

FIG. 2E shows a profile of each simulated diffraction pattern in FIGS. 2C and 2D. It is observed that the intensity of the diffraction wave is significantly increased owing to the presence of the resonant grating formed in the thin film 21. Thus, the invention allows a particle 25 to be detected with the highest sensitivity. The image obtained by the image sensor 30 allows the particle to be localized. It is understood that, when particles of different sizes are detected, the image allows the particles of the sample to be sorted by size.

The reinforcement of the intensity of the diffracted wave 26 is all the greater the smaller the dimensions of the particle 25. This effect is illustrated in FIG. 2F, showing, as a function of the diameter of the diffracting particle d₂₅, the variation of a ratio between the maximum intensity of a diffraction pattern obtained according to the first embodiment over the maximum intensity of a diffraction pattern obtained according to the prior art. It is observed that the gain in intensity provided by the invention is all the greater the smaller the dimensions of the observed particle.

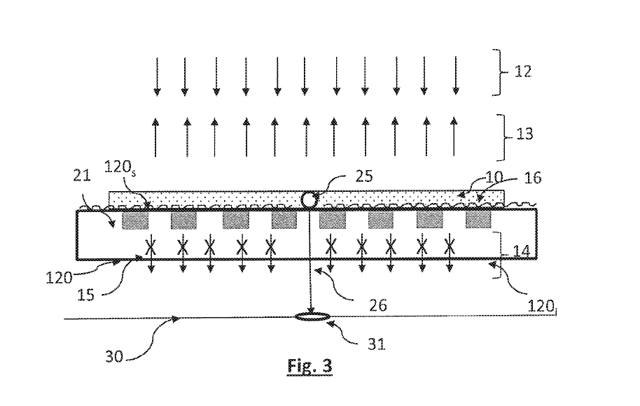

FIG. 3 shows a second embodiment, showing a substrate 120 in which the thin film 21, identical to that described in the preceding embodiment, rather than being adjacent to the lower face 120ᵢ, as in the preceding example described, is disposed adjacent to the upper face 120_{S}. The grating formed in the thin film 21 still allows a resonant reflection at a resonance wavelength, according to the operational principles described in relation with the preceding embodiment. The transmitted wave 14, not coupled to the grating, undergoes a destructive interference with the wave 15 decoupled from this grating. A particle 25 disposed in contact with the upper face 120ₛ, or at a small enough distance from the latter, typically a sub-wavelength distance, becomes a diffracting particle and generates a diffraction wave 26 propagating as far as the detection plane P of the image sensor 30. It then forms a diffraction pattern 31 on an image acquired by the image sensor 30, as previously described.

According to this embodiment, when the particle 25 is placed at a distance from the upper face 120ₛ, since the distance is greater than the wavelength, it is still able to produce a diffraction wave owing to its illumination by the incident wave 12. However, according to this configuration, the intensity of the diffraction wave 26 is not enhanced by the electromagnetic field confined within the diffraction grating formed in the thin film 21, owing to the fact that the particle is not situated in near field.

Thus, in this embodiment, the particle 25 may be placed at a distance or in contact with the substrate. In the latter case, the diffraction wave 26 is amplified by electromagnetic field confined within the thin film 21.

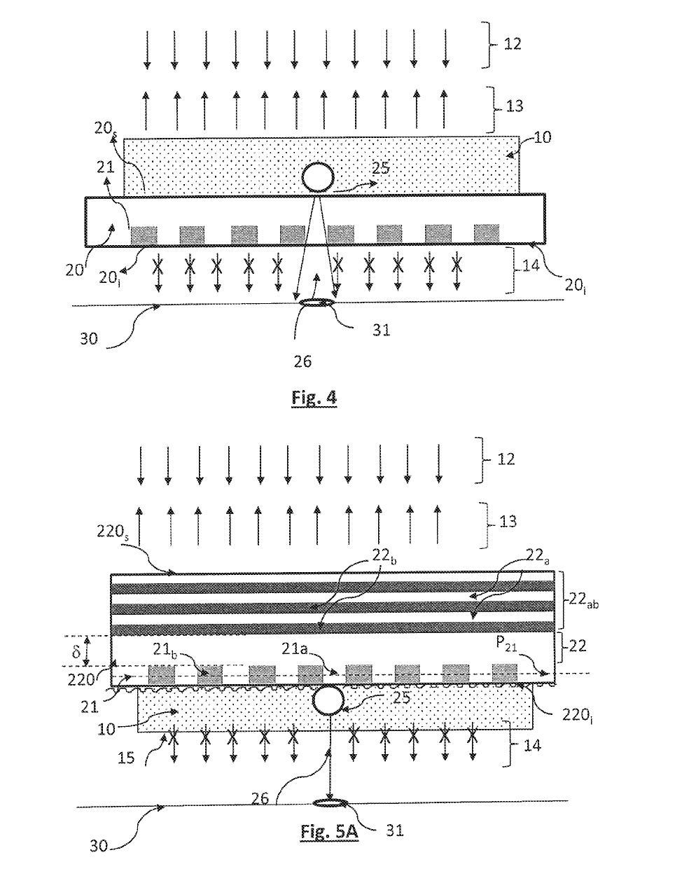

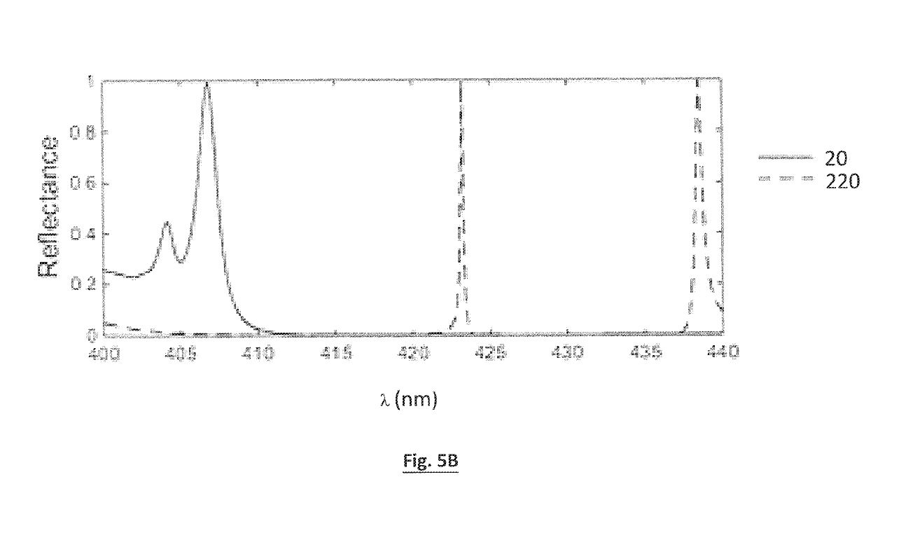

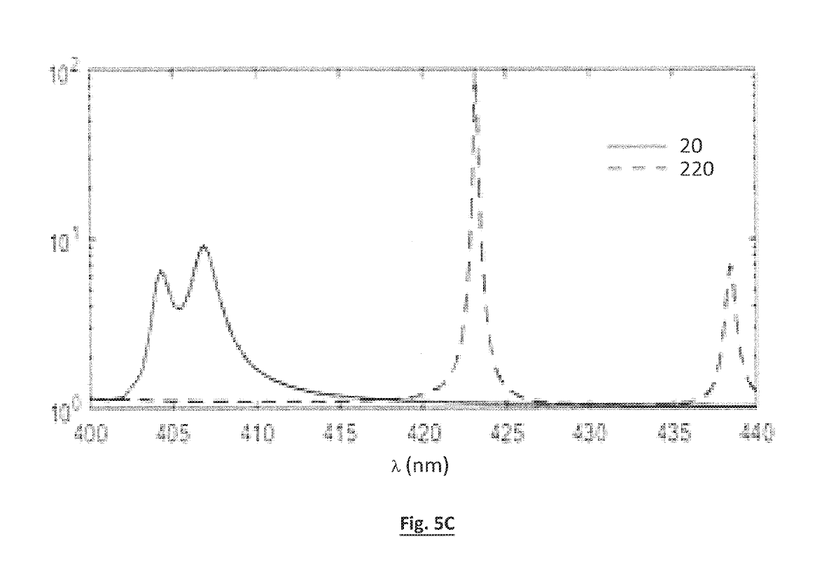

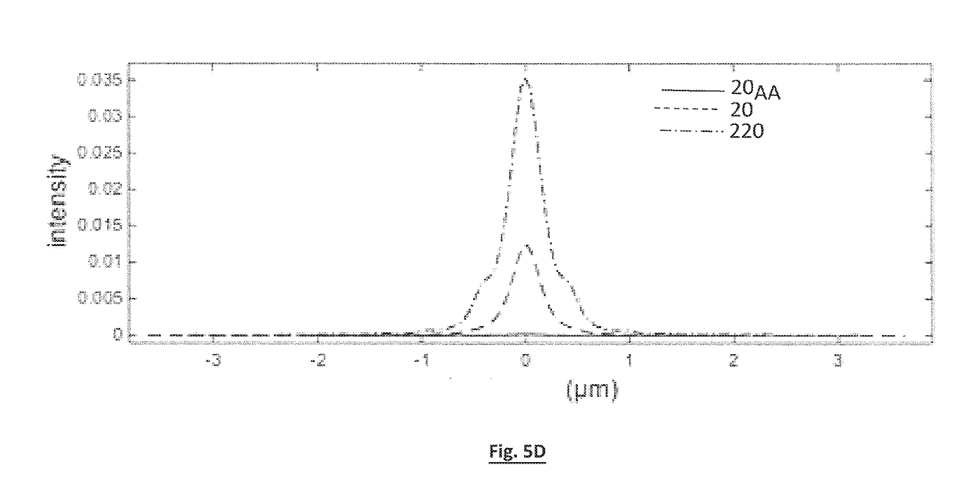

FIG. 4 shows a third embodiment of the invention, in which a particle is deposed between the upper face 20ₛ of the substrate 20, described in the first embodiment, whereas the thin film 21 is adjacent to the lower face 20ᵢ of this substrate. In a similar manner to the previous embodiments, the grating formed in the thin film 21 still allows a resonant reflection of the incident wave 12, emitting a wave reflected 13 with a reflectance close to 1 when illuminated at the resonance wavelength. The particle 25 is exposed to the incident wave 12 and forms a diffraction wave 26, whose angle of incidence with the thin film 21 is sufficient to be able to be transmitted to the image sensor 30. According to this embodiment, the image sensor remains in a dark field configuration, owing to the reflection of the incident wave 12 by the grating of the thin film. On the other hand, the intensity of the diffraction wave 26 is not increased by the electromagnetic field confined within this grating.

FIG. 5A shows a fourth embodiment comprising the same elements as that shown in FIG. 1. According to this embodiment, the substrate 220 furthermore comprises a Bragg mirror 22_{ab}, disposed between the thin film 21, previously described. It extends between an upper face 220ₛ, disposed opposite the light source 11, and a lower face 220ᵢ, placed opposite the image sensor 30. A Bragg mirror 22_{ab} is formed of a periodic stacking of dielectric, or semiconducting, layers whose optical thickness is an odd multiple of a quarter of the wavelength. One period of the multilayer is in particular composed of two layers, respectively formed of a third material 22ₐ with a third refractive index and a fourth material 22_{b}, with a fourth refractive index, said third index and fourth index being different. The difference between the third index and the fourth index is preferably greater than 0.25. The greater the number of periods, or the greater the difference between the indices of two successive layers, the higher the reflectance of the Bragg mirror 22_{ab}. Just as for the first and second materials, the third and fourth materials are transparent to all or part of the emission spectral band within which the incident wave 12 is emitted, and in particular, transparent to the resonance wavelength of the diffraction grating formed in the thin film 21.

A first advantage of this embodiment is that a Bragg mirror 22_{ab} allows the incident wave 12 to be reflected over a wide spectral band, in other words at wavelengths below and beyond the resonance spectral band of the diffraction grating of the thin film 21. Thus, this embodiment allows the use of a light source whose emission spectral band is wider, in comparison with the embodiments previously described.

Another advantage of this embodiment is the formation of destructive interferences with the vertically-radiating mode propagating toward the source. This increases the confinement time of the photons within the grating. This also increases the intensity of the electromagnetic field confined within the grating, leading to an increase in the intensity of the diffraction wave 26 formed by a particle 25 placed in near field, in other words at a sub-wavelength distance from the diffraction grating. The sensitivity of the device is therefore improved.

It is preferable for the distance 8 between the thin film 21 and the Bragg mirror 22_{ab} to be an odd multiple of λ/4. In other words, an optimum condition is δ≈k λ/4, k being an odd positive integer. Indeed, between the Bragg mirror and the resonant grating 21, the light wave is a stationary wave, whose intensity varies between a threshold value, close to 0, and a maximum value that may reach 4 times the intensity of the incident wave 12, the successive minima being separated by one wavelength λ, as are the maxima. The lower the incident intensity, on the resonant grating, the lower is also the coupling ratio Γ, and as a consequence, the greater the difficulty for the photons propagating within the resonant grating to be decoupled. Accordingly, the inventors estimate that it is preferable to dispose the thin film 21 at an intensity minimum, sometimes called node, of the incident wave 12 at the diffraction grating 21. Consequently, the intensity of the electromagnetic field confined within the grating is high, and notably higher than in the embodiments previously described. This results in an increase in the intensity of the diffraction wave 26 generated by a particle 25, which is confirmed by the results of simulations shown in FIG. 5C. In the simulations shown in FIGS. 5B to 5D, it has been considered that k is an odd integer.

k may be an even integer, in which case the coupling ratio Γ is higher. However, the decoupling is also higher, which does not allow an intensity of the confined beam to be obtained that is as high as when k is odd.

When k is an even integer, the quality factor of the resonant grating decreases, which is accompanied by a greater spectral tolerance for the grating.

FIG. 5B shows the variation of the reflectance of the grating as a function of 20 wavelength in two configurations: a first configuration using the substrate 20 described in relation with the first embodiment shown in FIGS. 1A and 1B, and a second configuration using the substrate 220 corresponding to the fourth embodiment, shown in FIG. 5A, the third and fourth materials (22ₐ and 22_{b} respectively) being respectively identical to the first and second materials (21ₐ and 21_{b} respectively) forming the thin film 21. The resonance wavelength varies between 405 nm (first configuration) and 423 nm (second configuration). An increase of the quality factor Q is also observed in the fourth embodiment. The detection sensitivity is therefore improved.

Furthermore, although the reflectance of the grating is optimum at the resonance wavelength, the use of a Bragg mirror 22_{ab} widens the spectral band within which the incident light wave 12 is reflected, in particular when the number of layers increases. It then becomes possible to use a light source 11 whose wavelength may be shifted with respect to the resonance wavelength.

FIG. 5C shows the variation of the intensity of the electric field, at the interface between the thin film 21 and the lower face of the substrate, according to these two configurations (substrate 20 and substrate 220), this intensity being representative of the intensity of the electromagnetic field. It is observed that the addition of a Bragg mirror 22_{ab} significantly increases the intensity of the confined field. The consequence of this is an increase in the intensity of the diffraction wave, and as a result, of the diffraction pattern 31 detected by the image sensor 30. The ordinate axis in this figure, representing the intensity, is associated with a logarithmic scale. FIG. 5D shows a comparison of the intensity of a diffraction pattern 31 produced by a bead 25 with a diameter of 100 nm and with an index of 1.5 placed against the lower face of the substrate. The comparison is carried out by considering the prior art (20_{AA}) the first embodiment (substrate 20) and fourth embodiment (substrate 220). It is observed that the Bragg mirror 22_{ab} allows, at the resonance wavelength of the grating 21, an increase in the intensity of the diffracted wave by a factor 3. The sensitivity of the device is therefore improved. In this configuration, the Bragg mirror 22_{ab} comprises a layer of silica (third material 22ₐ) and a layer of silicon nitride (fourth material 22_{b}).

Furthermore, although the preceding examples are described in relation to a normal incidence, the incident wave 12 may propagate along an axis of propagation Z forming an angle different from π/2 with the plane P₂₁ of the thin film 21, requiring only an adaptation of the resonance wavelength. The angle of incidence may in particular be varied over a range of angles, for example up to π/6 on either side of normal incidence, and this is true for all of the embodiments.

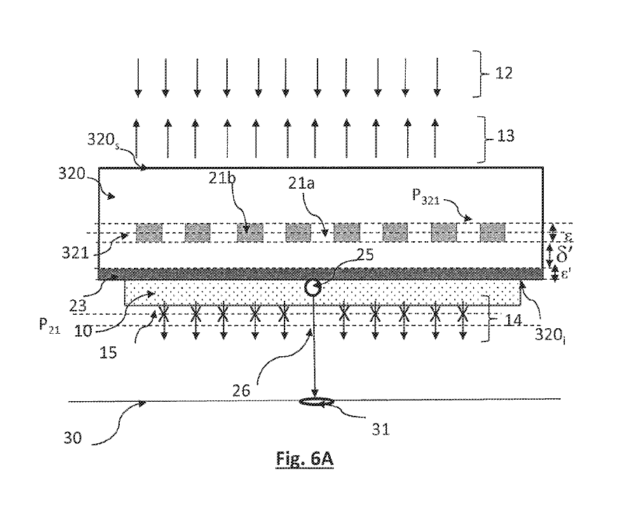

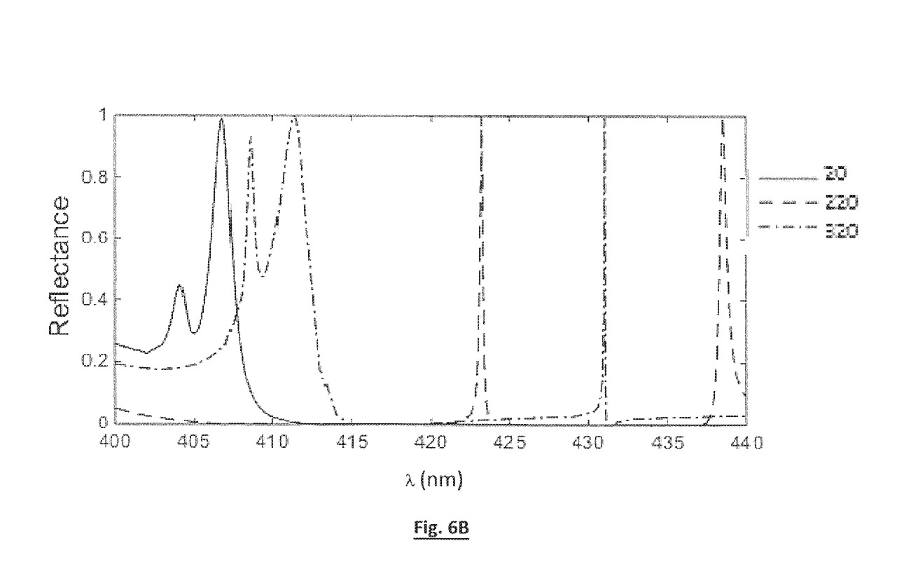

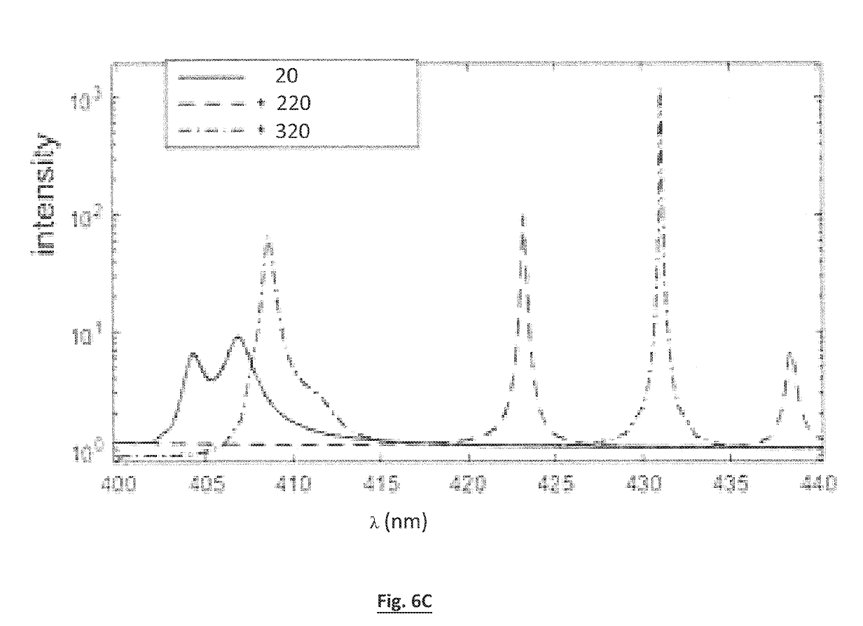

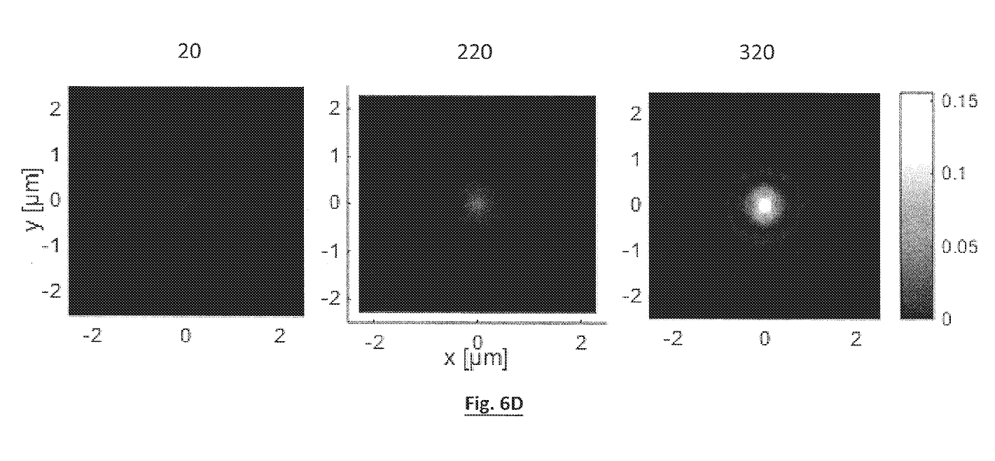

FIG. 6A shows a fifth embodiment, in which a substrate 320 extends between an upper face 320ₛ and a lower face 320ᵢ. The substrate 320 comprises a planar waveguide 23, adjacent to a lower face 320ᵢ of the substrate 320, disposed opposite the image sensor 30. This planar waveguide is formed with a fifth dielectric material, in this case silicon nitride. The thickness ε′ of the planar waveguide 23 is 110 nm. It is preferably less than the resonant wavelength of the diffraction grating 321, and in particular less than a half-wavelength. In this example, ε′=λ/2n₅, n₅ denoting the refractive index of the fifth material constituting the planar waveguide 23, in the present case silicon nitride.

In a similar manner to the preceding embodiments, the substrate 320 comprises a thin film 321, extending across a thin film plane P₃₂₁, the latter being composed of a first dielectric material 21a and comprises inclusions of a second dielectric material 21b, defining a diffraction grating. In contrast to the preceding embodiments, the function of the diffraction grating 321 is not to confine the light within said thin film. It is structured for coupling the incident light wave 12 to a guided mode of the planar waveguide 23, according to a coupling ratio Γ. In other words, the diffraction grating 321 is a coupler grating, allowing the confinement of a part of the incident wave 12 within the planar waveguide 23 extending parallel to the thin film 321. The wave generated by the diffraction grating 321 for exciting a guided mode of the waveguide 23 is an evanescent wave. The distance δ′ between the thin film 321 and the waveguide 23 is an important parameter, having a bearing on the coupling ratio Γ. Since the intensity of an evanescent wave decreases exponentially, it will be understood that, as the distance δ′ increases, the more the coupling ratio decreases. The lower the coupling ratio, the lower is also the decoupling ratio, which in turn increases the confinement time of the photons in the waveguide 23. The intensity of the electromagnetic field confined within the waveguide is then high owing to the low decoupling ratio.

In the same way as in the preceding embodiments, the radiation decoupled toward the image sensor constitutes a wave 15 forming destructive interferences with the residual wave 14, so called transmitted wave, not coupled to the waveguide 23, and propagating toward the image sensor along the axis of propagation Z. The illumination of the image sensor is therefore blocked. The radiation decoupled toward the light source forms a reflected wave 13.

Thus, the substrate acts as a mirror at the resonance wavelength, at which the coupling with a mode of the waveguide 23 takes place. In contrast to the preceding embodiments, the resonant reflection is obtained by the assembly formed by the diffraction grating 321, acting as a coupler grating, and the planar waveguide 23. In the preceding embodiments, the resonant reflection is obtained by the diffraction grating 21 alone, the latter confining the electromagnetic beam in the plane of the thin film 21, the latter acting as a waveguide.

In a manner common to all of the embodiments presented, the image sensor 30 is in a dark field configuration.

The distance δ′ between the diffraction grating of the thin film 321 and the planar waveguide 23 may be zero, the thin film 321 then being in contact with the waveguide 23. The coupling is high, but the intensity of the electromagnetic field in the waveguide is low, owing to a decoupling which is also high. When this distance is too large, for example greater than the wavelength, the coupling no longer takes place. Thus, the distance δ′ is preferably greater than 0, so as to be large enough to obtain a low coupling ratio, typically less than 1%. Typically, the distance δ′ is less than the wavelength. The inventors consider that a distance δ′ of λ/2n represents a good compromise, n denoting the index of the material extending between the planar waveguide 23 and the thin film 321, in the present case silica.

One important condition for an effective coupling to occur is that the period of the coupler grating, whether this be the period Px along the axis X or Py along the axis Y, is such that

$$Px = Py = \frac{λ}{{n}_{eff}} \qquad ( 1 )$$

n_{eff} being an effective index of the diffraction grating of the thin film.

The index n_{eff} is obtained by the following relationship:

$$k {ɛ}^{′} \sqrt{{n}_{c}^{2} - {n}_{eff}^{2}} - a tan ( {g}_{1} \frac{\sqrt{{n}_{eff}^{2} - {n}_{g 1}^{2}}}{\sqrt{{n}_{c}^{2} - {n}_{eff}^{2}}} ) - a tan ( {g}_{2} \frac{\sqrt{{n}_{eff}^{2} - {n}_{g 2}^{2}}}{\sqrt{{n}_{c}^{2} - {n}_{eff}^{2}}} ) - m π = 0 \qquad ( 2 )$$

with:

k=2π/λ;

m denotes the order of the mode, with m=1 in this example;

n_{c} is the index of the material forming the planar waveguide;

n_{g1} and n_{g2} are the indices of the materials flanking the planar waveguide, in the present case silica and air, respectively;

$${g}_{1} = \frac{{n}_{c}^{2}}{{n}_{g 1}^{2}} and {g}_{2} = \frac{{n}_{c}^{2}}{{n}_{g 2}^{2}} ,$$

The expressions (1) and (2) allow, knowing the materials forming the waveguide and adjacent to the waveguide, the resonance wavelength λ to be defined, together with the period of the coupler grating.

FIG. 6B shows the variation of the reflectance as a function of wavelength, respectively for the first embodiment (substrate 20 comprising a diffraction grating 21 alone), the fourth embodiment (substrate 220 comprising a Bragg mirror 22_{ab} and a diffraction grating 21) and this fifth embodiment (substrate 320 comprising a waveguide 23 coupled to a diffraction grating 321). A shift in the resonance wavelength at which the reflectance is a maximum is observed.

FIG. 6C shows the variation of the intensity of the confined electric field, on the lower face of the substrate, representative of the intensity of the confined electromagnetic field, as a function of wavelength, for the first embodiment (substrate 20), the fourth embodiment (substrate 220) and this fifth embodiment (substrate 320), respectively. This embodiment allows a maximum intensity to be obtained at the resonance wavelength of 431 nm. The quality factor Q is also higher than that of the previous embodiments.

When a particle 25 is placed in contact with the lower face 320ᵢ of the substrate 320, or at a sub-wavelength distance from the waveguide 23, it is subjected to an intense electromagnetic field confined within the waveguide, and forms a diffraction wave 26 propagating toward the detection plane of the image sensor 30, allowing the detection of a diffraction pattern 31. FIG. 6D shows simulations of the intensity of such a diffraction pattern, the diffraction wave 26 being produced by a bead of diameter 100 nm placed in contact with the lower face 320ᵢ, respectively, from left to right, for the first (substrate 20), fourth (substrate 220) and fifth embodiment (substrate 320), the scale of the grey levels being common. The intensity of the signal propagating over the detector is greater according to the configuration of the fifth embodiment. In addition, this embodiment is seen to offer the highest sensitivity.

FIG. 6E shows a simulation of an intensity profile, in the detection plane P, of the wave 26 diffracted by the particle 25 in the configurations described with regard to FIG. 6D. It confirms the best sensitivity of this fifth embodiment. As mentioned with respect to the previous embodiment, the image acquired by the image sensor enables the localization of the particle 25, as well as its identification and/or size sorting.

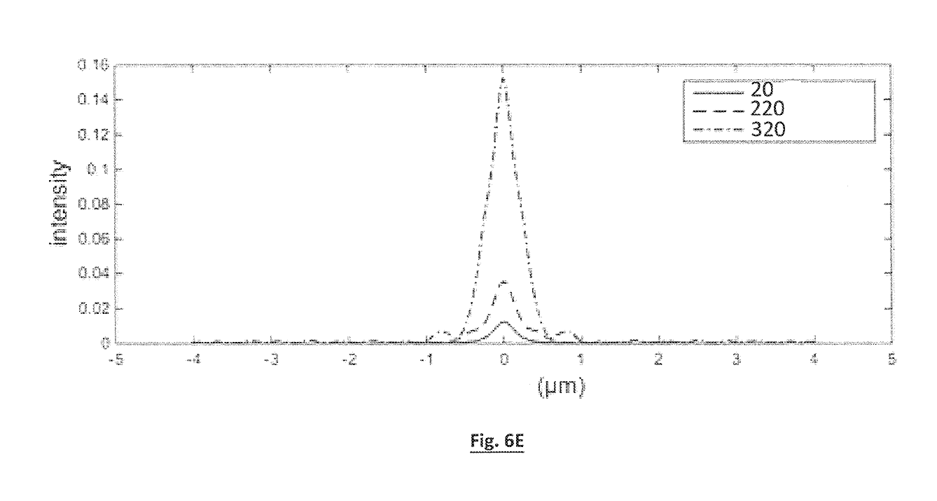

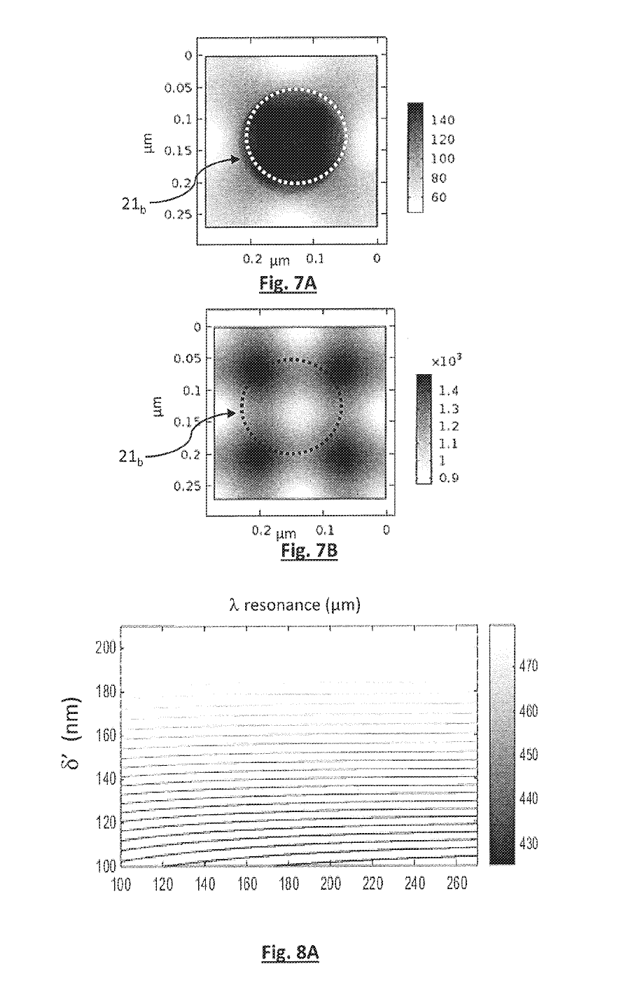

FIGS. 7A and 7B respectively show the spatial distribution of the intensity of the electric field on the lower face of the substrate, corresponding to the fourth embodiment and to the fifth embodiment, respectively. FIG. 7A is produced by considering that the diffraction grating of the thin film 21 of the substrate 220, described in relation with FIG. 5A, constitutes the waveguide. FIG. 7B is obtained by considering the fifth embodiment, in which the waveguide of the substrate 320 is the planar waveguide 23, the diffraction grating of the thin film 321 acting as a coupler grating. These figures show the trace of the inclusions formed in the diffraction grating by the second dielectric material 21_{b}. The scale of the abscissa and ordinate axes represents the transverse dimensions across the plane in which the waveguide extends, the units being in μm. It is observed that the intensity of the confined electromagnetic beam is more uniform in the fifth embodiment.

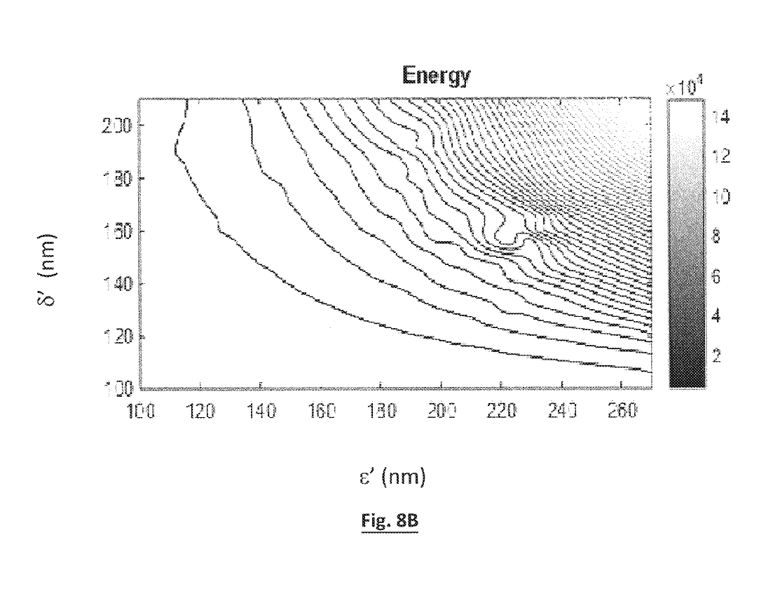

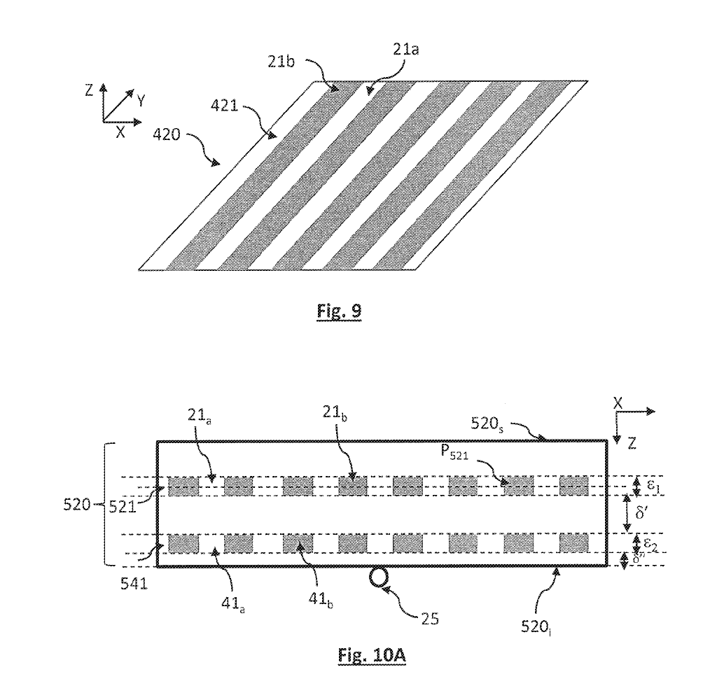

FIG. 8A shows one example of dimensional design of a diffraction grating according to this fifth embodiment. It shows the variation of the resonance wavelength as a function of the thickness ε′ of the planar waveguide 23, forming the abscissa axis, and the distance δ′ between the waveguide 23 and the diffraction grating formed in the thin film 321, forming the ordinate axis. FIG. 8B shows, as a function of the same parameters as FIG. 8A, the variation of the energy of the confined beam, at the interface between the thin film 321 and the lower face 320ᵢ of the substrate 320. FIGS. 8A and 8B illustrate the fact that the dimensional design of such an embodiment may be achieved with the aid of simulation codes available to those skilled in the art.

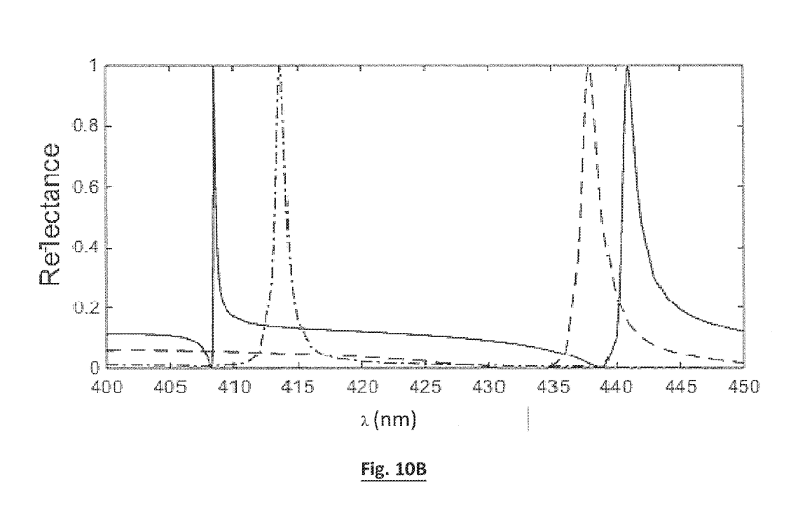

FIG. 9 shows a substrate 420 according to a sixth embodiment, extending between a lower face 420ᵢ and an upper face 420ₛ. The substrate 420 comprises a thin film 421, extending across a thin film plane P₄₂₁, and defining a diffraction grating running in only one dimension. The thin film 421 is formed from a first material 21a, for example silica. It comprises inclusions running in a longitudinal direction (along the axis Y), in the plane of the thin film, defining strips parallel to one another. Each inclusion has, in a direction perpendicular to said longitudinal direction, in other words along the axis X, a width less than the wavelength, or even less than half the wavelength. Such a grating is known by the designation “1D grating”, as opposed to the two-dimensional gratings described in the previous embodiments. It is possible to design such a grating in such a manner that it acts as a diffraction grating, in a manner analogous to the gratings shown in the previous embodiments, but with the use of a polarized light source.

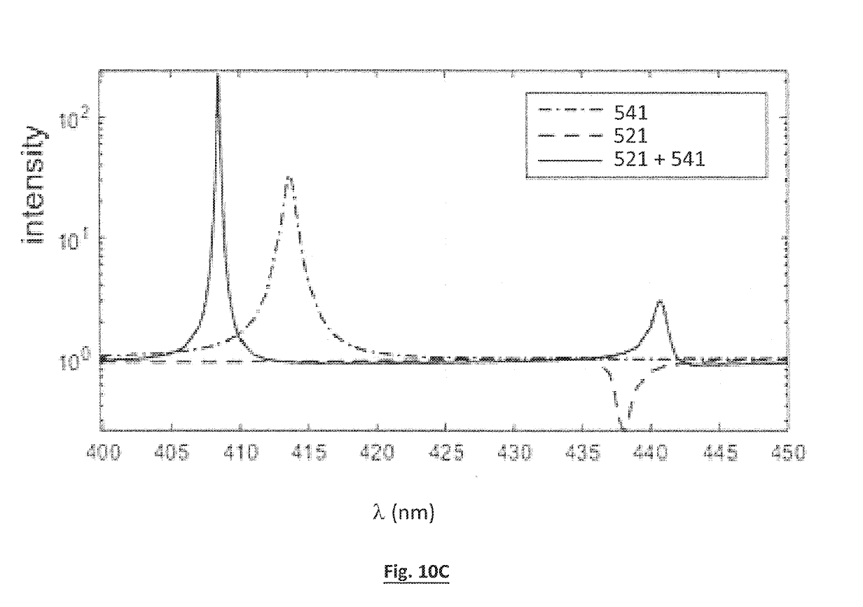

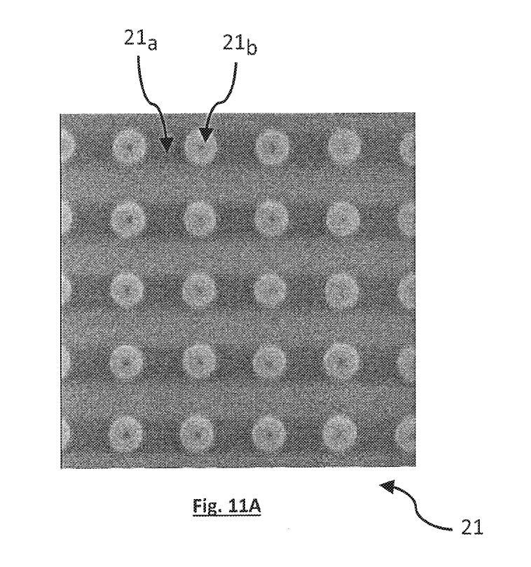

FIG. 10 shows a substrate 520 according to a seventh embodiment, extending between a lower face 520ᵢ and an upper face 520ₛ. The substrate 520 comprises two thin films 521, 541, separated from each other, each thin film forming a diffraction grating and extending parallel to a thin film plane P₅₂₁. In FIG. 10A, the substrate comprises a first thin film 521 comprising a first material 21ₐ, in the present case silica, in which inclusions composed of a second material, in the present case silicon nitride, 21_{b} are formed running in parallel strips, in a manner analogous to the embodiment shown in FIG. 9. This first thin film, with a thickness ε₁=130 nm, forms a first diffraction grating, with a period of 264 nm, the width of each inclusion being 132 nm.

The substrate 520 comprises a second thin film 541 comprising a sixth material 41ₐ, in the present case silica, in which inclusions 41_{b} are formed composed of a seventh material, in the present case silicon nitride, running in parallel strips in a manner analogous to the first thin film 521. This second thin film, of thickness ε₂=150 nm, forms a second diffraction grating with a period of 264 nm, the width of each inclusion being 158 nm. The distance δ′ between the first and the second thin film is equal to 100 nm. The second thin film is situated at a distance δ″ of 50 nm from the lower face 20ᵢ of the substrate 20. According to this embodiment, the sixth and seventh materials respectively correspond to the first and to the second material.

Thus, according to this embodiment, the substrate comprises a first diffraction grating and a second diffraction grating, running parallel to each other, and separated by a distance of less than the wavelength.

FIGS. 10B and 10C respectively show the variation of the reflectance and the intensity of the electric field, as a function of wavelength, in various configurations. Each diffraction grating taken in isolation is first of all simulated. In this case, the curves in FIGS. 10B and 10C respectively show the reflectance of each grating, and the intensity of the electric field confined within each grating (521, 541). Then, a substrate comprising the two combined gratings (521+541) has been simulated, such as shown in FIG. 10A. In the latter case, the intensity of the electric field modeled in FIG. 10C corresponds to the second grating 541, the latter running between the first grating 521 and the lower face 520; of the substrate 520, at a distance of 50 nm from the latter. The reflectance corresponds to the reflectance of the combination of the two gratings. It turns out that the combination of the two gratings significantly increases the intensity of the electromagnetic field confined within the diffraction grating closest to the lower face 520ᵢ of the substrate 520, the latter being intended to be placed in contact or near to a particle 25 of the sample. The shift in the resonance length between each grating taken in isolation and the combination of the gratings is noted.

The resonance wavelength of each grating may be different, as can be observed in this example. It may also be identical, to within a given uncertainty, for each grating. In this case, the first and the second grating have the same structure, and when the spacing between the two gratings is equal to the half the wavelength, the two gratings then form a Fabry-Perot cavity.

These simulations show that several diffraction gratings, preferably running parallel to one another, may be formed within a substrate 520. The preceding example describes a superposition of two one-dimensional diffraction gratings, but the invention naturally covers the superposition of two-dimensional diffraction gratings, such as described in the previous embodiments.

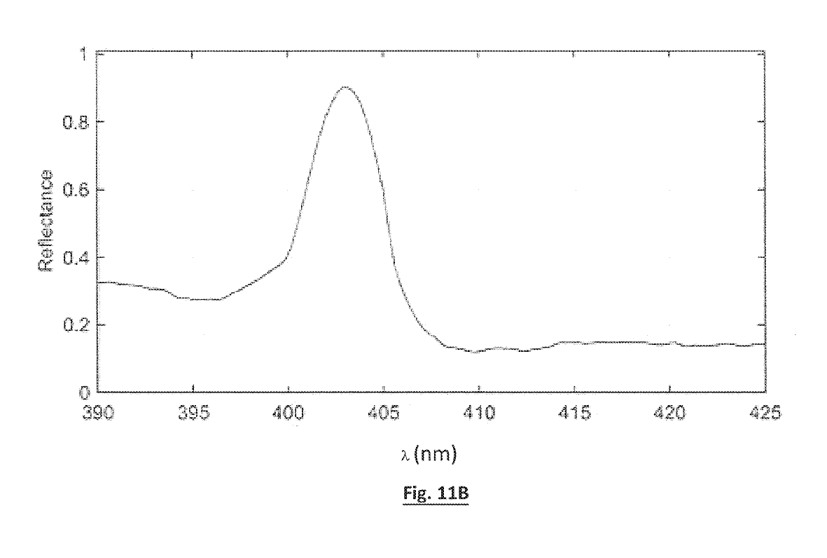

FIG. 11A and 11B respectively show a two dimensional diffraction grating 21, as described with respect to the first embodiment, and the variation of the reflectance as a function of the wavelength using this two dimensional grating. The variation of the reflectance was measured. FIG. 11A was obtained using an electron scanning microscope. This figure shows cylinder shaped silicon nitride inclusions 21_{b} within a thin film of silica 21ₐ. The diameter of each inclusion 21_{b} is about 120 nm, while the period of the grating is 270 nm. FIG. 11B shows the variation of the reflectance that was measured using the diffraction grating 21 displayed on FIG. 11A. These measurements are quite consistent with the simulated data of FIG. 2A.

Although, in the examples described, the diffraction grating is obtained using inclusions of silicon nitride within a thin film of silica, this pair of materials is in no way limiting and the invention could implement other materials, with the proviso of a sufficient difference in index, in particular greater than 0.25. Air holes within a matrix of silica may for example be envisioned. This observation goes for all of the embodiments, including for the materials constituting the Bragg mirror described in the fourth embodiment. The precise dimensional design of each grating may be obtained by those skilled in the art by implementing processing codes simulating the propagation of electromagnetic waves, allowing the structuring, the period of the grating, the resonance wavelength and also the quality factor to be defined.

The gratings described in this description may be fabricated using known microfabrication techniques, for example electron-beam lithography, known as e-beam lithography, photolithography (for example at a wavelength of 193 nm) or by an imprint technique.

1. A device for forming an image of a sample comprising:
a light source, configured to emit a light wave, referred to as incident wave, at a wavelength, along an axis of propagation, toward the sample;
an image sensor;
a substrate, configured to receive the sample, disposed between the light source and the image sensor;
the substrate comprising a first thin film, comprising a first material, transparent at said wavelength, with a first refractive index, extending across a plane, referred to as plane of the thin film,
said first thin film comprising a plurality of inclusions, formed from a second material, transparent at said wavelength, with a second refractive index;
the distance between two adjacent inclusions being less than said wavelength;
said inclusions defining a first bi-dimensional diffraction grating, within said first thin film, designed to confine a part of the incident wave across a plane parallel to said thin film plane;
the device not comprising magnification optics between the substrate and the image sensor.

2. The device as claimed in claim 1, in which the first diffraction grating is designed for generating a resonant reflection of the incident wave at said wavelength so as to reflect a part of said incident light wave toward the light source.

3. The device as claimed in claim 1, in which, the substrate being bounded by a lower face and an upper face, said first thin film is configured to confine a part of the incident light within a waveguide adjacent to one of said faces.

4. The device as claimed in claim 3, in which the first thin film is adjacent to one of said faces, the first diffraction grating being a resonant grating, designed to confine a part of the incident wave within said thin film plane, said first thin film then forming said waveguide.

5. The device as claimed in claim 3, in which the substrate also comprises a Bragg mirror, disposed between the light source and said first thin film, and formed by at least two adjacent layers, extending parallel to said thin film, formed from a third material with a third index and a fourth material with a fourth index, said third index being different from said fourth index.

6. The device as claimed in claim 5, in which the third material and the fourth material correspond respectively to the first material and to the second material.

7. The device as claimed in claim 5, in which the Bragg mirror is placed at a distance from the first thin film substantially equal to an odd multiple of a quarter of the wavelength.

8. The device as claimed in claim 1, in which the substrate comprises a second thin film, extending parallel to said first thin film,
the second thin film comprising a sixth material, transparent at said wavelength, with a sixth refractive index;
said second thin film comprising a plurality of inclusions, formed from a seventh material transparent at said wavelength, with a seventh refractive index;
two adjacent inclusions of said second thin film being separated from each other by a distance less than said wavelength, in such a manner that these inclusions define a diffraction grating in said second thin film, designed to confine a part of the incident wave in said second thin film;
the distance between the first thin film and the second thin film being less than said wavelength.

9. The device as claimed in claim 3, in which:
the substrate comprises a planar waveguide, running parallel to said first thin film;
said first thin film is disposed between said planar waveguide and the light source, the first diffraction grating being configured for generating an optical coupling with the planar waveguide, in such a manner that a part of the incident wave is coupled to said planar waveguide;
the distance between the first thin film and said planar waveguide being greater than zero and less than said wavelength.

10. The device as claimed in claim 9, in which the substrate is bounded by a lower face, disposed facing the image sensor, and in which the planar waveguide is adjacent to said lower face.

11. The device as claimed in claim 1, in which each inclusion is
cylindrical or conical, with a circular or polygonal base,
or hemispherical,
the diameter or the largest diagonal being less than said wavelength.

12. The device as claimed in claim 1, in which each inclusion takes the form of a strip, running in a longitudinal direction in the plane of said first thin film, the width of said inclusion, in a direction perpendicular to said longitudinal direction, being less than said wavelength.

13. The device as claimed in claim 1, in which the thickness of the first thin film is less than 1 μm.

14. The device as claimed in claim 1, in which the grating defined by the inclusions in the first thin film is periodical.

15. The device as claimed in claim 1, in which the first materials and the second materials of the thin film are chosen from amongst dielectric or the semi-conductor materials.

16. A device for forming an image of a sample comprising:
a light source, configured to emit a light wave, referred to as incident wave, at a wavelength, along an axis of propagation, toward the sample;
an image sensor;
a substrate, configured to receive the sample, disposed between the light source and the image sensor;
the substrate comprising a first thin layer including first inclusions, forming a first diffraction grating;
the substrate also comprising a second thin layer including second inclusions forming a second diffraction grating, said second this layer extending parallel to the first thin layer;
the distance between the first thin layer and the second thin layer being less than said wavelength;
the first diffraction grating and the second diffraction grating being designed to confine part of the incident wave in the second thin film.
the device not comprising magnification optics between the substrate and the image sensor.

17. A method of observation of a sample, comprising a particle, the method comprising the following steps:
disposing the sample in contact with a substrate, said substrate being disposed between a light source and an image sensor;
illuminating the substrate and the sample by means of an incident light wave, produced by the light source;
the substrate comprising a first thin film, extending across a thin film plane, forming a first diffraction grating, confining a part of the incident wave in a plane parallel to said plane of the thin film, so as to form a confined beam propagating in said plane parallel to the thin film plane;
collecting, on the image sensor, a diffraction wave generated by said particle, and acquiring an image representative of this diffraction wave, the diffraction wave being formed by the particle from the confined beam, a part of the diffraction wave being detected by the image sensor.

18. The method as claimed in claim 17, in which the substrate reflects a part of the incident wave and blocks a transmission of the incident wave toward the image sensor.

19. The method as claimed in claim 17, in which
the substrate is bounded by a lower face and an upper face, the lower face being situated opposite to the image sensor;
said first thin film confines a part of the incident light within a waveguide adjacent to one of said faces, so as to form a beam referred to as ‘confined beam’ propagating within said waveguide;
and, in which the sample is placed in contact with the face bounding said waveguide.

20. The method as claimed in claim 17, in which the waveguide is formed by said first thin film.

21. The method as claimed in claim 20, in which the substrate comprises a second thin film, extending parallel to said first thin film, and forming a second diffraction grating designed to confine a part of the incident wave within said second thin film, the first and the second thin film being separated from each other by a distance less than said wavelength.

22. The method as claimed in claim 19, in which the waveguide is a planar waveguide, adjacent to the lower face of the substrate, the first thin film acting so as to couple a part of the incident wave to said planar waveguide.

23. The method as claimed in claim 17, in which said particle is disposed at a distance from said waveguide of less than said wavelength.

24. The method as claimed in claim 17, in which the particle is a biological particle, for example a micro-organism or a virus or a cell.

25. The method as claimed in claim 17, in which the sample comprises a liquid, in which said particle is immersed.
